(19) United States
(12) Patent Application Publication
(10) Pub. No.: US 2007/0070915 A1
(43) Pub. Date: Mar. 29, 2007

(54) Apparatus and method for correlating quality information on different layers of a network and a medium thereof

(76) Inventors: Robert Herman Kroboth, Peyton, CO (US); Per Daniel Kangru, Uppsala (SE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/237,687

(22) Filed: Sep. 29, 2005

(51) Int. Cl. H04J 1/16; H04J 3/16

(52) U.S. Cl. 370/252; 370/469

(57) ABSTRACT

An apparatus, method and medium thereof to automatically correlate quality information of different layers of a network based on a layered stack model and to perform root cause analysis on the network in accordance with the correlated quality information. The correlated quality information is displayed on a graphical display.

### BACKGROUND OF THE INVENTION

### DESCRIPTION OF THE RELATED ART

Networks such as mobile networks, telecommunication networks and datacom networks are typically based on layered stack models which include several different layers each having a different function within the network. Many problems may occur on the lower layers of the model which are the root cause of significant problems on the upper layers of the model.

FIG. 1 is a diagram illustrating a conventional layered stack model of a monitored data link in a network environment. In FIG. 1, the layered stack model is an open system interconnect model (OSI), for example. The lower layers (i.e., layers 1-3) of the layered stack model include a physical layer 60, a data link layer 70, and a network layer 80. The upper layers (i.e., layers 4-7) of the layered stack model include a transport layer 90, a session layer 100, a presentation layer 110 and an application layer 120. The functions of each layer are well-known to one skilled in the art and therefore a description thereof will be omitted herein.

FIG. 2 is a diagram illustrating the lower layers of the conventional layered stack model shown in FIG. 1. Now referring to FIG. 2, problems of the lower layers 1-3 are shown which may result in significant problems on upper layers 4-7 of the layered stack model. For example, many dropped calls and voice quality issues may occur on the upper layers. As shown in FIG. 3, a problem has occurred on the physical layer 60 which leads to a loss of an ATM cell at the data link layer 70. The loss of the ATM cell causes a damaged AAL-5 frame at the network layer 80, and the damaged AAL-5 frame may lead to dropped calls or dropped data connection on a mobile network in the upper layers.

Conventional methods of analyzing problems occurring on the network are drawn to analyzing the different layers, independently. That is, conventional methods analyze the lower layers and the upper layers, separately. However, the conventional methods do not allow interlayer analysis between the different layers for the purpose of preventing potential issues which may occur on the upper layers.

### BRIEF DESCRIPTION OF THE DRAWINGS

Aspects and advantages of the invention will become apparent and more readily appreciated from the following description of the preferred embodiments, taken in conjunction with the accompanying drawings of which:

FIG. 1 is a diagram illustrating a conventional layered stack model of a monitored data link in a network environment;

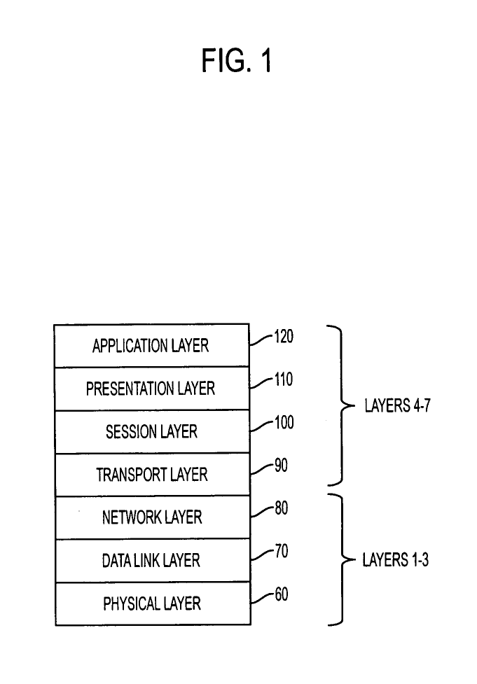

FIG. 2 is a diagram illustrating the lower layers of the conventional layered stack model shown in FIG. 1.

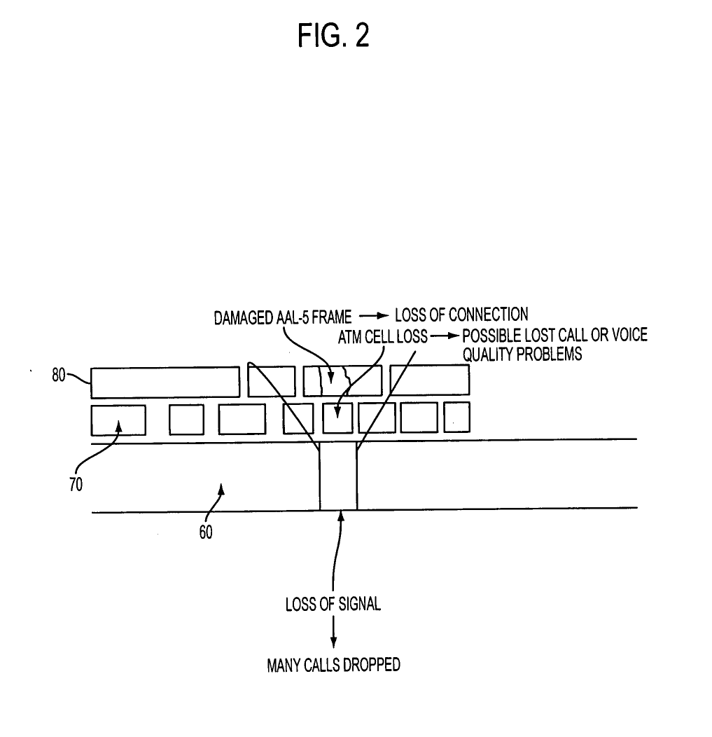

FIG. 3 is a diagram illustrating a network environment according to an embodiment of the present invention;

FIG. 4 is a flow chart illustrating a method according to an embodiment of the present invention;

FIG. 5 is a graphical display illustrating correlated quality information according to an embodiment of the present invention;

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

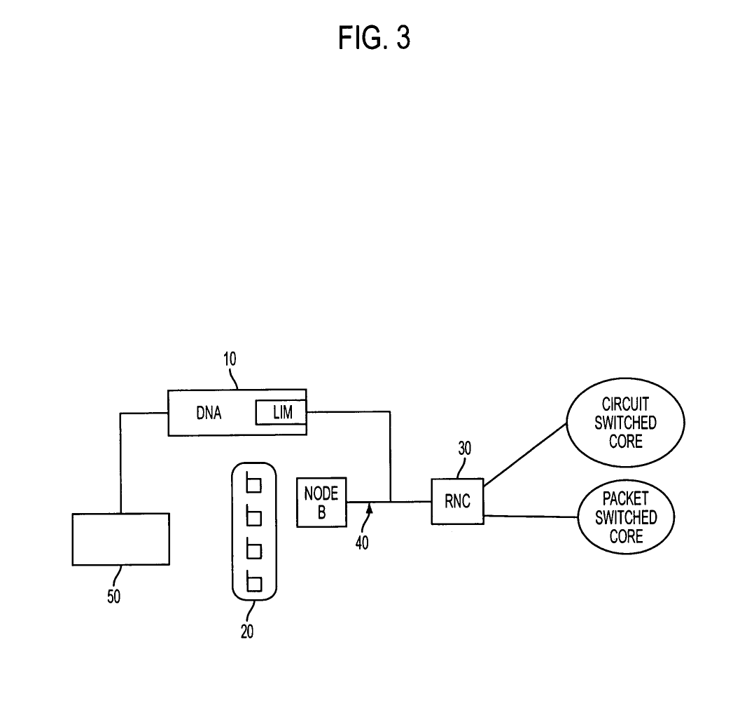

FIG. 3 is a diagram illustrating a distributed monitoring system of a network environment according to an embodiment of the present invention. In FIG. 3, A radio base station, Node B provides a gateway between phones 20 and a radio network controller (RNC) 30 via an luB interface 40 which is an interface between Node B and the radio network controller 30. The luB interface 40 may be an ATM over STM-1/OC-3 type interface. However, the luB interface 40 is not limited any particular type of interface and may vary as necessary.

The RNC 30 hands over active calls from the phones 20, via the luB interface 40. In the network environment according to an embodiment of the present invention, both Circuit-Switched data and Packet-Switched data may be handled simultaneously.

A distributed network analyzer (DNA) 10 having a plug-in line interface (LIM) monitors the lub interface 40 and captures and performs a segmentation and reassembly (SARs) process of the data corresponding to the data link being monitored. That is, the DNA 10 obtains ATM cells from the lower layers via the monitored connection. The ATM cells are organized into AAL-2 or AAL-5 frames typically used by mobile specific protocols, to prepare the data to be further analyzed. Quality information is extracted from the cells, and the frames from the cells are then reassembled. The DNA 10 then sends the captured data to a signaling analyzer 50 to be further analyzed.

The data link being monitored may be one of an optical, electrical or RF link.

The signaling analyzer 50 receives the captured data from the DNA 10 and processes the captured data and extracts mobile specific protocol messages and obtains mobile specific quality information from the extracted mobile specific protocol messages such as dropped calls, for example, from the upper layers.

The extracting of the mobile specific protocol messages is described in co-pending U.S. patent application Ser. No. 11/116,721 filed Apr. 28, 2005, Robert H. Kroboth, et. al., Method and Apparatus for Depicting Quality of Service in Mobile Networks, assigned to Agilent Technologies, and incorporated herein by reference.

Further, in the signaling analyzer 50, the quality information corresponding to the different layers in the network is automatically correlated. The different layers comprise at least one of a lower layer and an upper layer of the layered stack model. For example, the quality information corresponding to the cells (i.e., lower layer quality information) and the mobile specific quality information (i.e., upper layer quality information) is aggregated for predetermined time intervals. That is, the quality information corresponding to the cells and the mobile specific quality information is time-stamped for predetermined time intervals and stored in buckets corresponding to each predetermined time interval for later use. The predetermined time intervals may be fixed by the system or set by a user. Then, a root cause analysis on the network is performed in accordance with the correlated quality information. Therefore, in the present invention, interlayer analysis between the different layers may be performed for the purpose of preventing potential issues, which may occur on the upper layers. That is, the quality information of the lower layers can be used to evaluate the performance of the upper layers of the layered stack model.

The DNA 10 may be one of Agilent Model Nos. J6848 or J6801A. However, the DNA 10 is not limited to any particular model, and may vary as necessary. Further, the signaling analyzer 50 may be one of Agilent Model Nos. J7326A or J7348. However, the signaling analyzer 50 is also not limited to any particular model, and may vary as necessary.

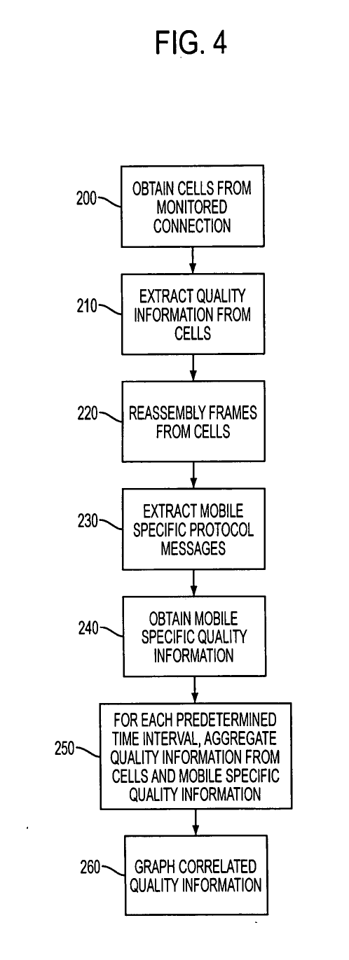

FIG. 4 is a flow chart illustrating a method according to an embodiment of the present invention. Now referring to FIG. 4, at operation 200, in the DNA, cells are obtained from a monitored connection of the network. From operation 200, the process moves to operation 210, quality information is extracted from the obtained cells. From operation 210, the process moves to operation 220, where the ATM frames from the cells are reassembled. From operation 220, the process moves to operation 230, where the signal analyzer receives the data from the DNA and mobile specific protocol messages are extracted from the data received.

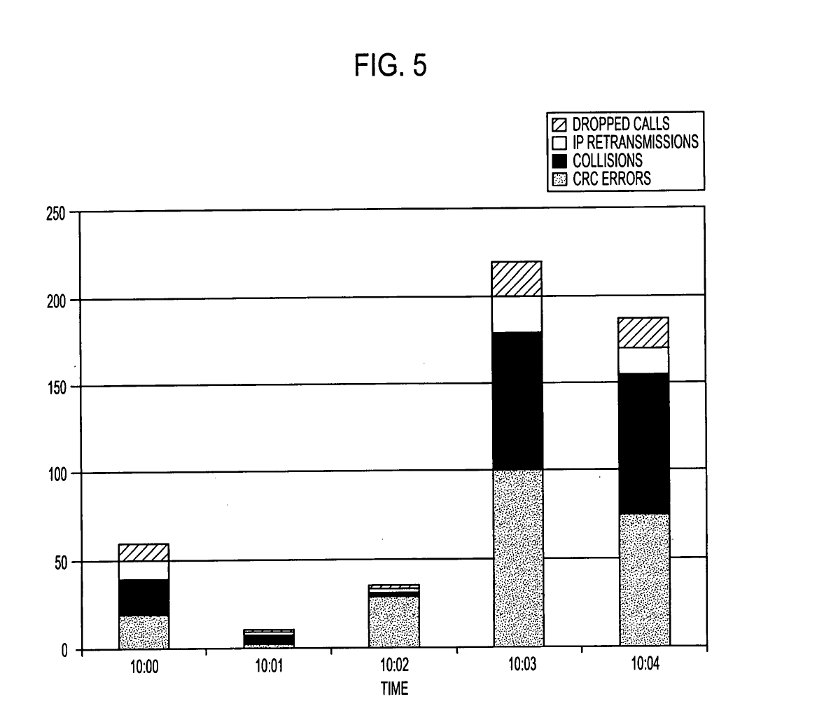

From operation 230, the process moves to operation 240, where mobile specific quality information is obtained from the mobile specific protocol messages. Then, from operation 240, the process moves to operation 250, where quality information from the cells and the mobile specific quality information from the mobile specific protocol messages is aggregated for predetermined time intervals. The aggregated quality information is automatically correlated and time-stamped for each predetermined time intervals, and stored in buckets corresponding to each predetermined time interval. Then, from operation 250, the process moves to operation 260 where the buckets for the predetermined time intervals are obtained, and the correlated quality information stored in the buckets is plotted on a graph over time and displayed in a graphical display on the signaling analyzer (see FIG. 5, for example).

FIG. 5 is a graphical display illustrating correlated quality information according to an embodiment of the present invention. Now referring to FIG. 5, the stacked bar graph illustrates correlated quality information being plotted over time at time intervals of a second. However, the present invention is not limited to any particular time intervals, and may vary as necessary.

On Table 1 shown below corresponding to the graphical display shown in FIG. 5, quality information obtained from the cells by the DNA 10 is events which occur on lower layers of the layered stack model, for example, IP retransmissions, collisions, and CRC errors, and quality information obtained by the signaling analyzer 50 is events which occur at upper layers of the layered stack model, for example, dropped calls. The quality information on the lower layers and the upper layers is shown correlated for predetermined time intervals. For example, in Table 1, at 10:00, there are 20 CRC errors, 20 collisions, 10 IP retransmissions and 10 dropped calls. The quality information of the present invention is not limited hereto, and may vary as necessary.

TABLE 1
Time (in seconds)

| | 10:00 | 10:01 | 10:02 | 10:03 | 10:04 |
|---|---|---|---|---|---|
| CRC Errors | 20 | 3 | 30 | 100 | 75 |
| Collisions | 20 | 5 | 2 | 80 | 80 |
| IP Retransmissions | 10 | 2 | 2 | 20 | 15 |
| Dropped Calls | 10 | 1 | 2 | 20 | 18 |

As shown in Table 1 above, the quality information on the lower layers and the upper layers is time-stamped at specific time intervals and aligned with one another, and displayed on a graphical display of the signaling analyzer, as shown in FIG. 5. The graph may be a stacked bar graph as shown in FIG. 5, or a line graph. However, the present invention is not limited to any particular type of graph and may vary as necessary.

Further, an automated list of recommendations based upon the correlated quality information may be generated, to thereby prevent potential issues from occurring on the upper layers.

In addition to the above-described embodiment, embodiments of the present invention can also be implemented through computer readable code/instructions in/on a medium, e.g., a computer readable medium.

The medium can correspond to any medium/media permitting the storing and/or transmission of the computer readable code. The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. In particular, the media may also be a distributed network, so that the computer readable code is stored/transferred and executed in a distributed fashion.

Additional aspects and advantages of the invention will be set forth in part in the description which follows, and, in part, will be apparent from the description, or may be learned by practice of the invention.

It is another aspect of the present invention to provide a computer readable medium implementing a method to be performed by a computer, the method comprising automatically correlating quality information of different layers of a network based on a layered stack model, and performing root cause analysis on the network in accordance with the correlated quality information.

It is yet another aspect of the present invention to provide an apparatus comprising an analyzer to monitor and capture data of a network based on a layered stack model, and a means for processing the captured data to obtain quality information of different layers of the layered stack model, for automatically correlating the quality information of the different layers and for performing root cause analysis on the network in accordance with the correlated quality information.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
automatically correlating quality information of different layers of a network based on a layered stack model; and
performing root cause analysis on the network in accordance with the correlated quality information.

2. The method of claim 1, further comprising:
automatically correlating quality information of a lower layer and an upper layer of the network for predetermined time intervals; and
time-stamping and storing the correlated quality information in buckets corresponding to each predetermined time interval.

3. The method of claim 2, further comprising:
generating and displaying a graphical display indicating the correlated quality information.

4. The method of claim 3, further comprising:
generating and displaying an automated list of recommendations based upon the correlated quality information, to thereby prevent potential issues from occurring on the upper layer.

5. The method of claim of claim 1, wherein the layered stack model is an open systems interconnection (OSI) model.

6. A computer readable medium implementing a method to be performed by a computer, the method comprising:
automatically correlating quality information of different layers of a network based on a layered stack model; and
performing root cause analysis on the network in accordance with the correlated quality information.

7. An apparatus comprising:
an analyzer to monitor and capture data of a network based on a layered stack model; and
a means for processing the captured data to obtain quality information of different layers of the layered stack model, for automatically correlating the quality information of the different layers and for performing root cause analysis on the network in accordance with the correlated quality information.
